(19) United States
(12) Patent Application Publication
(10) Pub. No.: US 2024/0091838 A1
(43) Pub. Date: Mar. 21, 2024

(54) FORMING METHOD OF PROCESSING CURVE IN STAMPING PROCESS

(71) Applicant: INDUSTRIAL TECHNOLOGY RESEARCH INSTITUTE, Hsinchu (TW)

(72) Inventors: Po-Huang SHIEH, Zhunan Township (TW); Hsuan-Yu HUANG, Taipei City (TW); Ming-Cheng TSAI, New Taipei City (TW); Yi-Ping HUANG, Taoyuan City (TW)

(73) Assignee: INDUSTRIAL TECHNOLOGY RESEARCH INSTITUTE, Hsinchu (TW)

(21) Appl. No.: 17/994,761

(22) Filed: Nov. 28, 2022

(30) Foreign Application Priority Data
Sep. 16, 2022 (TW) 111135146

(51) Int. Cl. B21D 22/02

(52) U.S. Cl. CPC B21D 22/02

(57) ABSTRACT

A forming method of a processing curve in a stamping process is provided. The method includes the following steps. A plurality of processing curves are established, and an optimization target is set for the processing curves according to material characteristics of a workpiece, process requirements and a finished product CAD file. At least two of the processing curves are selected and superimposed to form a basic forming curve, wherein each subsection of the basic forming curve corresponds to a selected processing curve. Whether the selected processing curve in each subsection of the basic forming curve matches the optimization target is determined.

This application claims the benefit of Taiwan application Serial No. 111135146, filed Sep. 16, 2022, the subject matter of which is incorporated herein by reference.

### TECHNICAL FIELD

The disclosure relates in general to a stamping process, and more particularly to a forming method of a processing curve in a stamping process.

### BACKGROUND

Along with the increase in the strength of material and the complexity of stamping piece, the speed, stamping performance and flexibility of conventional stamping press needs to be adjusted to meet the clients' unique requirements and applications.

Currently, the server stamping press can only select template curves such as the stamping process curve of FIG. 1 for stamping. Examples of commonly used template curves include Crank curve, Link curve, Hold curve, Vibration curve, and Half curve. The application of the Link curve is for the puncher to slow down in the forming stroke, so that the forming stability of the workpiece can be increased, the reverse load can be reduced, and mold lifespan can be prolonged. The application of the Hold curve is for the puncher to hold pressure at the bottom dead center of the workpiece during a predetermined time period, so that the heated workpiece can be formed and in-mold cooled. The application of the Half curve is for the puncher to forge the workpiece at the bottom dead point, so that the amount of springbuck of the workpiece can be reduced or the springbuck effect of the workpiece can be eliminated.

In a conventional stamping process of a workpiece, one of the above template curves is selected according to experience. However, if the workpiece ruptures, another template curve is selected. Therefore, the operator can only determine which template curve is the most suitable stamping curve according to experience. Since the forming curve cannot be optimized according to the process requirements in advance, the problem of workpiece rupture frequently occurs, and parameter adjustment can only rely on repetitive experiments.

### SUMMARY

The disclosure is directed to a forming method of a processing curve in a stamping process capable of selecting and superimposing processing curves according to the material characteristics of a workpiece, process requirements and a finished product CAD file and optimizing each superimposed processing curve to generate an optimized forming curve.

According to one embodiment of the present disclosure, a forming method of a processing curve in a stamping process is provided. The method includes the following steps. A plurality of processing curves are established, and an optimization target is set for the processing curves according to material characteristics of a workpiece, process requirements and a finished product CAD file. At least two of the processing curves are selected and superimposed to form a basic forming curve, wherein each subsection of the basic forming curve corresponds to a selected processing curve. Whether the selected processing curve in each subsection of the basic forming curve matches the optimization target is determined.

The above and other aspects of the disclosure will become understood with regard to the following detailed description of the preferred but non-limiting embodiment(s). The following description is made with reference to the accompanying drawings.

### BRIEF DESCRIPTION OF THE DRAWINGS

FIG. 1 is an example diagram of curves of a stamping process in prior art.

FIG. 2A is a flowchart of a forming method of a processing curve in a stamping process according to an embodiment of the disclosure.

FIG. 2B is a flowchart of n optimization process of a processing curve.

FIG. 2C is a flowchart of a forming optimization process of a basic processing curve.

FIG. 2D is a flowchart of a hold optimization process of a basic processing curve.

FIG. 3A is a schematic diagram of a cross section of a finished product;

FIG. 3B is a schematic diagram of a workpiece converted to a finished product through a stamping process.

FIGS. 4A-4C respectively are schematic diagrams of each processing curve and its corresponding forming stage in a stamping process according to an embodiment of the disclosure.

FIG. 5A is a flowchart of a forming optimization process according to an embodiment of the disclosure.

FIG. 5B is a relationship diagram of rupture strain value vs strain rate.

FIG. 6A is a flowchart of a hold optimization process according to an embodiment of the disclosure.

FIG. 6B is a schematic diagram of reference value of decision holding time parameter.

FIGS. 7A and 7B are diagrams of material limit range and forming limit corresponding to principal strain value and secondary strain value.

### DETAILED DESCRIPTION

Technical solutions for the embodiments of the present disclosure are dearly and thoroughly disclosed with accompanying drawings. Obviously, the embodiments disclosed below are only some rather than all of the embodiments of the present disclosure. All embodiments obtained by anyone ordinarily skilled in the technology field of the present disclosure according to the disclosed embodiments of the present disclosure are within the scope of protection of the present disclosure if the obtained embodiments lack innovative labor. Similar/identical designations are used to indicate similar/identical elements.

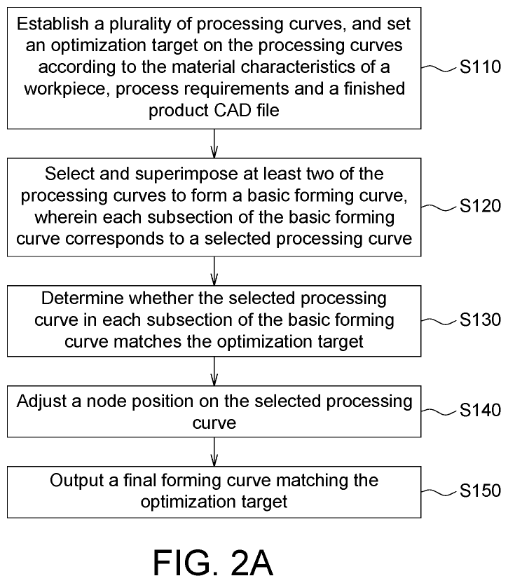

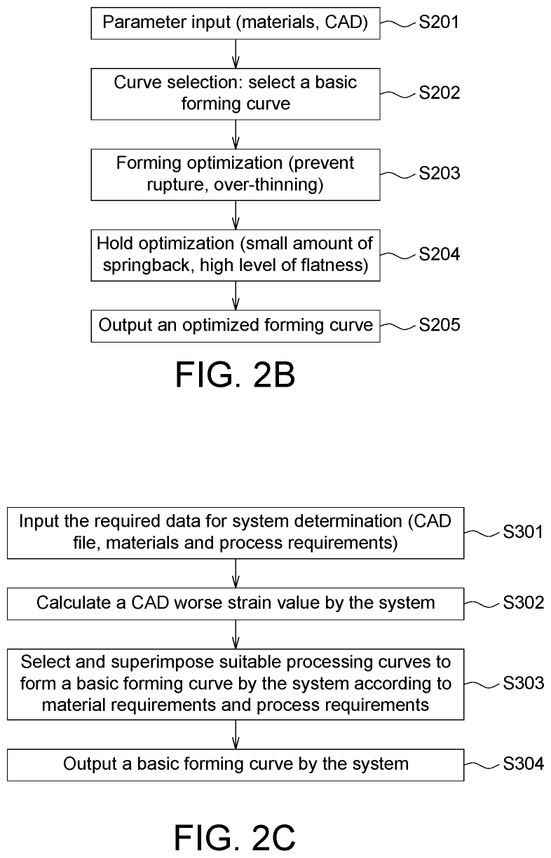

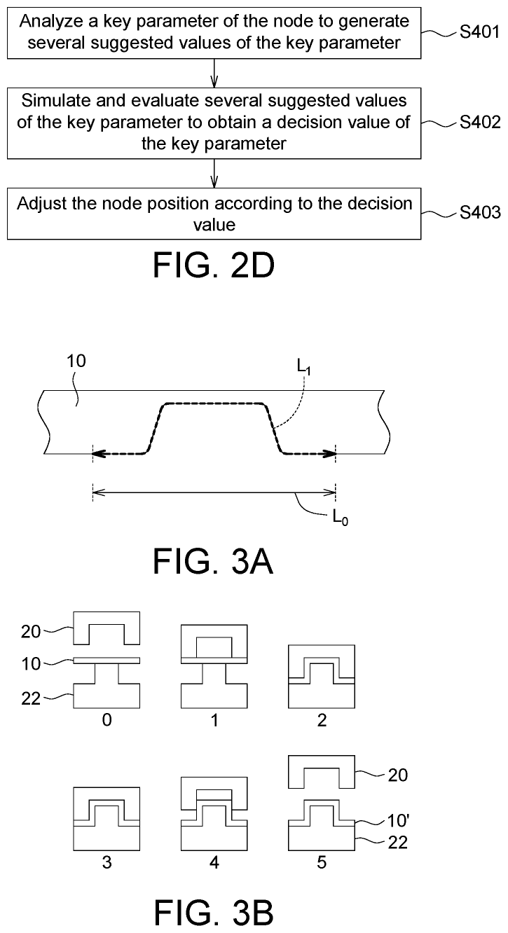

Referring to FIG. 2A, a flowchart of a forming method of a processing curve in a stamping process according to an embodiment of the disclosure is shown. Firstly, the method begins at step S110, a plurality of processing curves are established, and an optimization target is set for the processing curves according to the material characteristics of a workpiece, process requirements and a finished product CAD file. In step S120, at least two of the processing curves are selected and superimposed to form a basic forming curve, wherein each subsection of the basic forming curve corresponds to a selected processing curve. In step S130, whether the selected processing curve in each subsection of the basic forming curve matches the optimization target is determined. In step S140, a node position on the selected processing curve is adjusted. In step S150, a final forming curve matching the optimization target is outputted.

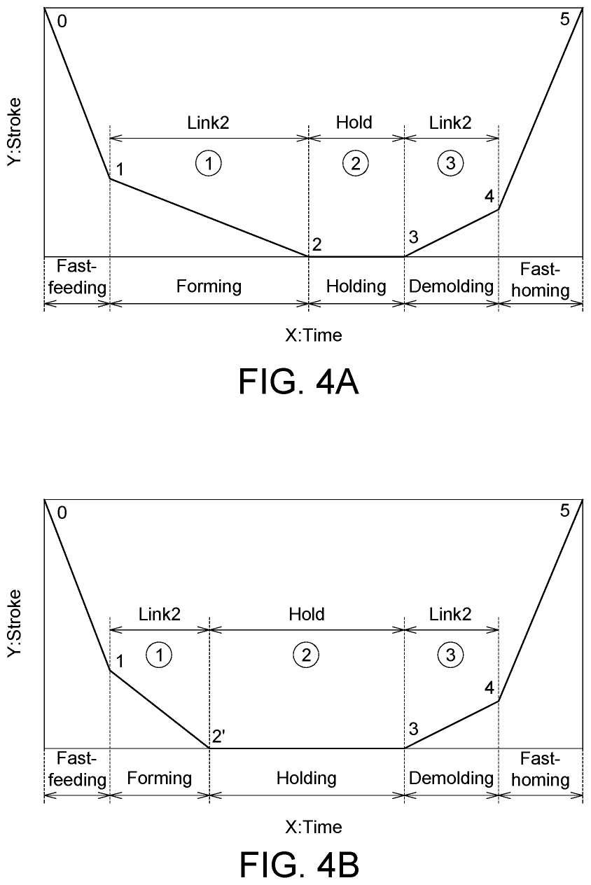

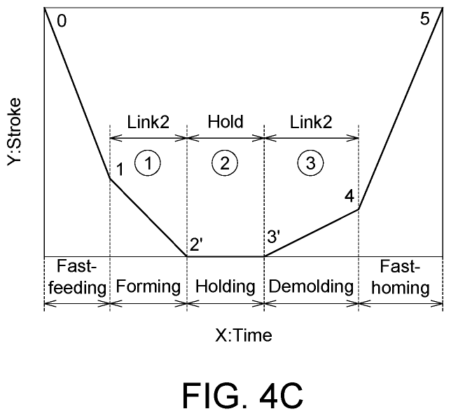

Referring to FIG. 2B, a flowchart of an optimization process of a processing curve is shown. In an embodiment, the present system obtains an optimum forming curve (S205) through parameter input (S201), curve selection (S202) and curve optimization (3203, S204). Parameter input (S201) includes inputting material characteristics, a finished product computer aided design (CAD) file, and so on. Curve selection (S202) includes superimposing at least two of the processing curve to form a basic forming curve matching the manufacturing process according to the material characteristics of a workpiece and process requirements (as indicated in FIG. 4A). Next, curve optimization includes forming optimization (S203) (prevent rupture, over-thinning) and hold optimization (S204) (low springbuck and high level of flatness).

Referring to FIG. 20, details of the curve selection process of step S202 are disclosed below. The selection of processing curve includes the following steps. Firstly, a finished product CAD file, and the materials and process requirements for the forming of a finished product are inputted (S301), wherein the process requirements include the type of stamping press used by the user, quality requirements and material ductility. Next, a CAD worse strain value is calculated by system according to the finished product CAD file (S302). Then, suitable processing curves are selected and superimposed to form a basic forming curve by the system according to material requirements and process requirements (S303). Then, a basic forming curve is outputted by the system (S304), but the nodes on each processing curve have not yet been optimized.

Referring to FIG. 2D details of the curve optimization process of steps S203 and S204 are disclosed below. The curve optimization process (forming optimization process and hold optimization process) includes: adjusting a node position on the selected processing curve (that is, step S140 of FIG. 2A). In step 3140, a key parameter of the node is analyzed to generate several suggested values of the key parameter (3401); several suggested values of the key parameter are simulated and evaluated to obtain a decision value of the key parameter (3402); the node position is adjusted according to the decision value (S403).

To put it in greater details, after the finished product CAD file is inputted, several cross sections of the finished product at different positions are obtained. Take FIG. 3A, a cross-sectional view of the workpiece 10, for instance. After the workpiece is stamped, a worse strain value is obtained according to the strain values of several cross sections of the finished product at different positions. The strain value is calculated according to the equation: (L₁−L₀)/L₀, wherein L₀ represents the length measured before the forming process; L₁ represents the length measured after the forming process. That is, the worse strain value of the cross sections of the finished product obtained after the forming process can be calculated according to the ratio of the difference between the length measured after the forming process L₁ and the length measured before the forming process L₀ to the length measured before the forming process L₀.

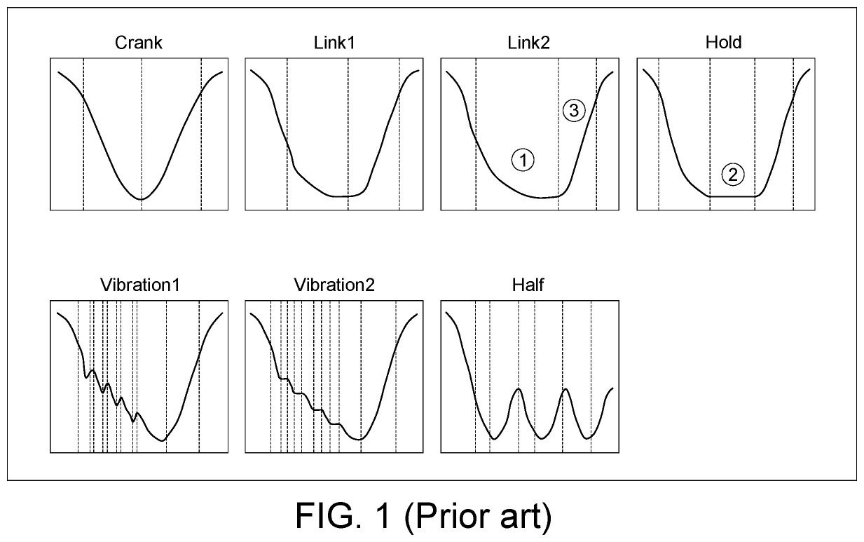

After the worse strain value of the finished product is obtained, the system determines which processing curves is suitable or unsuitable to be selected according to material requirements and process requirements. The material requirements and process requirements can be determined by using a decision tree or random forest analysis algorithm. Also refer to FIG. 1. Examples of material requirements and process requirements include parameters such as material, stamping press, mold, size and finished product. When the worse strain value of the finished product is less than 10%, the requirements for materials and manufacturing process are not strict, therefore the system can select an ordinary Crank curve for processing. When the worse strain value of the finished product is between 10-20%, and a large amount of springback is required of the material, the system can select the Hold curve. When the worse strain value of the finished product is between 10-20%, and an easily ruptured material is required, the system can select the Vibration 2 curve. When the worse strain value of the finished product is between 10-20%, and high precision and stability are required of the finished product, the system can select the Link 2 curve. Additionally, when the worse strain value of the finished product is greater than 20%, and a large amount of springback is required of the material, the system can select the Hold curve. When the worse strain value of the finished product is greater than 20%, and an easily ruptured material is required, the system can select the a Vibration 1 curve. When the worse strain value of the finished product is greater than 20%, and high precision and stability are required of the finished product, the system can select the Link 2 curve.

According to the decision tree analysis disclosed above; to meet the material requirement of a large amount of springbuck and the finished product requirements of high precision and stability, the system can select and superimpose the Hold curve and the Link 2 curve to form a basic forming curve (such as select the template segments \textcircled{1}+\textcircled{2}=\textcircled{3} (in FIG. 1); to meet the material requirement of easy rupture and the finished product requirements of high precision and stability, the system can select and superimpose the Vibration 1 curve and the Link 2 curve to form a basic forming curve, and the rest can be obtained by the same analogy.

Referring to FIGS. 4A, 4B and 4C, schematic diagrams of each processing curve and its corresponding forming stage in a stamping process according to an embodiment of the disclosure are respectively shown. The Y axis represents a stamping stroke; the X axis represents time; each of the numeric values 0-5 represents a node; each subsection between two nodes corresponds to a processing stage. For instance, the subsection between node 0 and node 1 corresponds to a fast-feeding stage; the subsection between node 1 and node 2 (i.e., forming curve) corresponds to a forming stage; the subsection between node 2 and node 3 (i.e., hold curve) corresponds to a holding stage, the subsection between node 3 and node 4 (i.e., demolding curve) corresponds to a demolding stage; the subsection between node 4 and node 5 corresponds to a fast-homing stage.

Refer to FIGS. 4A and 3B. FIG. 3B is a schematic diagram of a workpiece converted to a finished product through a stamping process. After having been stamped by the upper and lower molds 20 and 22, the workpiece can form a finished product 10′. In the present embodiment, the processing stages from left to right respectively are fast-feeding stage, forming stage, holding stage, demolding stage and fast-homing stage. The upper mold 20 does not contact the workpiece 10 at the fast-feeding stage, the demolding stage and the fast-homing stage, but contacts the workpiece 10 at the forming stage and the holding stage, so that each processing stage can match the material requirements and the process requirements, and each subsection of the basic forming curve corresponds to a selected processing curve. For instance, to meet the requirements of workpiece forming, the subsection between node 1 and node 2 can select the template segment \textcircled{1} of the Link 2 curve, wherein the Link 2 curve enables the puncher to slow down during the forming stroke, so that the forming stability of the workpiece can be increased, the reverse load can be decreased and the mold lifespan can be prolonged. Besides, to meet the requirements of workpiece holding, the subsection between node 2 and node 3 can select the template segment \textcircled{2} of the Hold curve, wherein the Hold curve enables the puncher to press and hold the workpiece at the bottom dead center during the preset time period to form and in-mold cool the heated workpiece. Also, to meet the requirements of workpiece demolding, the subsection between node 3 and node 4 can select the template segment \textcircled{3} of the Link 2 curve, wherein the Link 2 curve enables the puncher to slow down during the demolding stroke, so that the demolding stability of the workpiece can be increased, the reverse load can be decreased and the mold lifespan can be prolonged.

The above disclosure shows that to meet various material requirements and process requirements, the system can select and superimpose at least two of the processing curve to form a basic forming curve. For instance, the Link 1 curve+the Vibration 1 curve+the Link 1 curve, or the Crank curve+the Hold curve+the Link 2 curve, and the disclosure does not have specific restrictions regarding the above selections.

Following the above steps of selecting and superimposing curves (S110 and S120), in step S130, whether the selected processing curve in each subsection of the basic forming curve matches the optimization target is determined. For example, (1) the optimization target at the forming stage is to avoid the workpiece being ruptured or over-thinned, that is, the optimization target is set according to the forming limit of the material. Therefore, the system obtains suitable forming temperature interval and strain rate interval according to the employed material to determine whether the rupture strain value of the material is greater than the worse strain value of the finished product and perform forming simulation and evaluation to reduce the risk of the workpiece being ruptured or over-thinned; moreover, the system can further calculate the probability of the finished product being ruptured according to the forming limit of the employed material to reduce the risk of the workpiece being ruptured or over-thinned. (2) The optimization target at the holding stage is such as a small amount of springbuck and high level of flatness. Therefore, the system obtains a suitable critical temperature and a holding time according to the employed machine to determine whether the hold temperature and time are greater than the critical values and to perform forming simulation and evaluation to reduce the amount of springbuck of the workpiece and increase the size precision of the workpiece. (3) The optimization target at the demolding stage is such as demolding speed and temperature. Therefore, the system obtains suitable demolding speed interval and cooling temperature according to the employed material to reduce the risk of the workpiece being demolded.

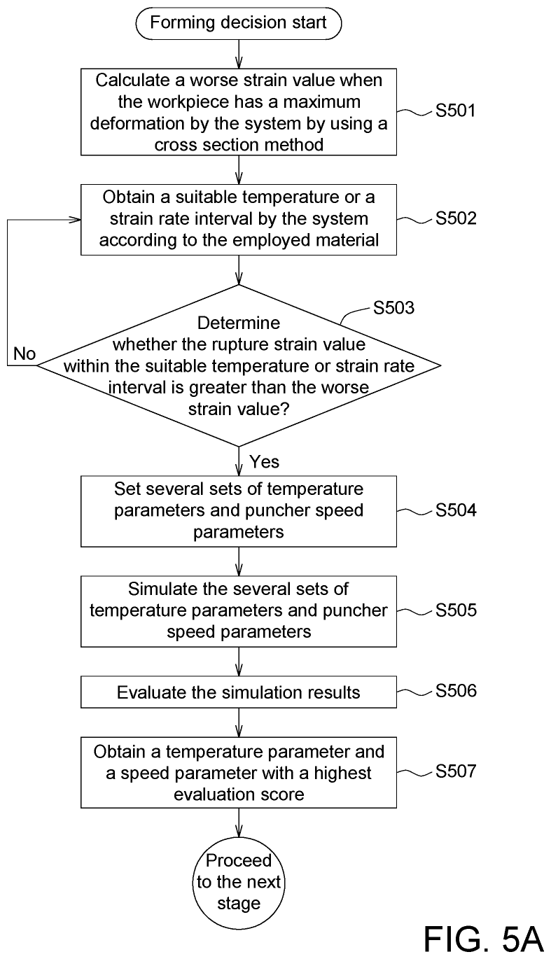

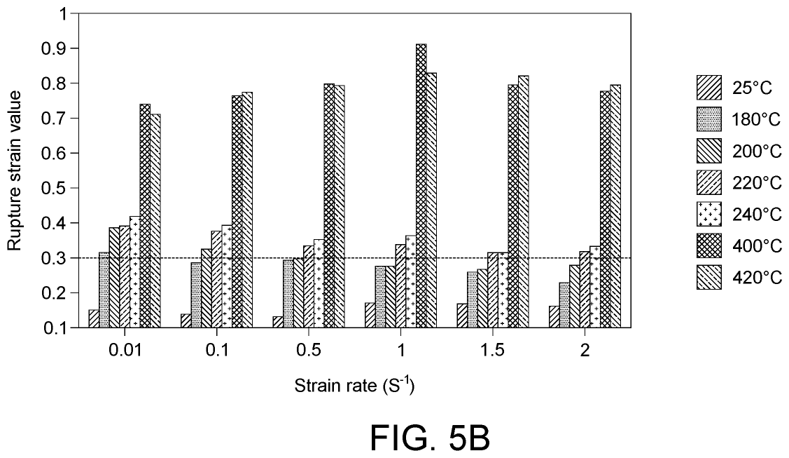

Refer to FIGS. 5A and 5B. FIG. 5A is a flowchart of a forming optimization process according to an embodiment of the disclosure. FIG. 5B is a relationship diagram of rupture strain value vs strain rate. In the forming optimization process, an optimum node position is obtained according to the following steps. Firstly, a worse strain value when the workpiece has a maximum deformation is calculated by the system by using a cross section method (S501). The strain value is calculated according to the equation: (L₁−L₀)/L₀, that is, the ratio of the difference between the length measured after the forming process L₁ and the length measured before the forming process L₀ to the length measured before the forming process L₀. Details of the equation are already disclosed above, and are not repeated here. Then, a suitable temperature or a strain rate interval is obtained by the system according to the employed material (S502) to determine whether the rupture strain value of the material within the suitable temperature and the strain rate interval is greater than the worse strain value of the finished product (S503). The strain rate refers to the deformation generated by an object when receiving an external force or being exposed at a specific temperature, and the strain per unit time is referred as strain rate. As indicated in FIG. 5B, when the rupture strain value is greater than the worse strain value (such as 0.3), the strain rate interval is between 0.5 and 2, and a temperature is greater than 220° C. is selected as a suitable temperature. If the selected temperature is outside the strain rate interval and the rupture strain value of the material is less than the worse strain value of the finished product, another suitable temperature and another rupture strain value can be selected outside the said range. If the selected temperature is within the strain rate interval and the rupture strain value of the material is greater than the worse strain value of the finished product, then several sets of temperature parameters and puncher speed parameters are set (S504) (that is, step S401, a key parameter of a node is analyzed to generate several suggested values). Then, several sets of temperature parameters and puncher speed parameters are simulated (S505), and the simulation results are evaluated (S506) to obtain a temperature parameter and a speed parameter with a highest evaluation score (S507) (that is, step S402, several suggested values of the key parameter are simulated and evaluated to obtain a decision value of the key parameter). Then, node position is adjusted by the system according to the decision value (S403).

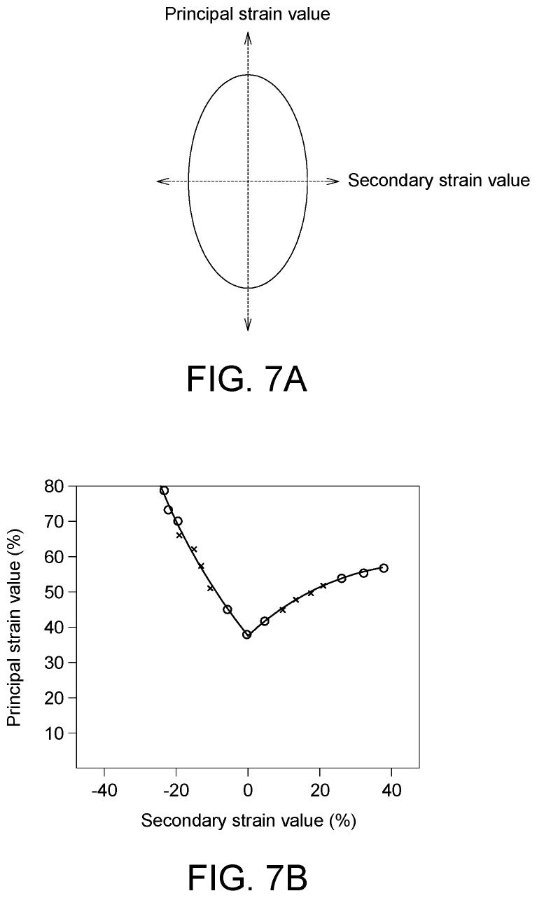

For instance, at temperature 220° C., several values of the puncher speed parameters (such as 700 min/s, 525 min/s, 350 min/s, 175 min/s, 80 min/s) are simulated, the simulation result of each puncher speed parameter is evaluated according to a forming limit diagram (FLD). As indicated in FIG. 7A, the material limit range of a forming limit diagram is obtained by measuring the principal strain value and secondary strain value of a workpiece with a standard round grid engraved thereon before the workpiece is stamped and becomes ruptured, the vertical coordinate (principal strain) and the horizontal coordinate (secondary strain) are shown at the forming limit diagram, and different workpieces have different material limit ranges. As indicated in FIG. 7B, the curve formed by the strain values is referred as forming limit diagram (FLD). During the forming process of the workpiece, when the strain value is outside the material limit range, the workpiece is prone to the risk of over-thinning and rupture. The forming limit diagram (FLD) is the most convenient and intuitive method for determining and evaluating the forming function of a workpiece. Thus, the system can quickly obtain the temperature and speed parameters with a highest evaluation score according to the forming limit diagram and thinning rate of the employed material.

As indicated in FIGS. 4A and 4B, the adjustment of node position includes moving at least one node position on the Link 2 curve (for instance, node 2′ is moved leftward with respect to node 2), so that the optimized subsection of the processing curve (the subsection between node 1 and node 2′ of the processing curve) corresponds to the temperature and speed parameters with a highest evaluation score.

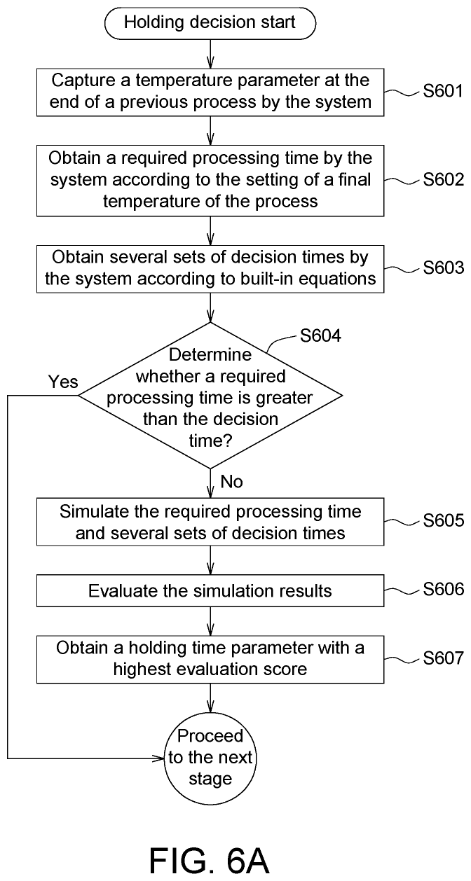

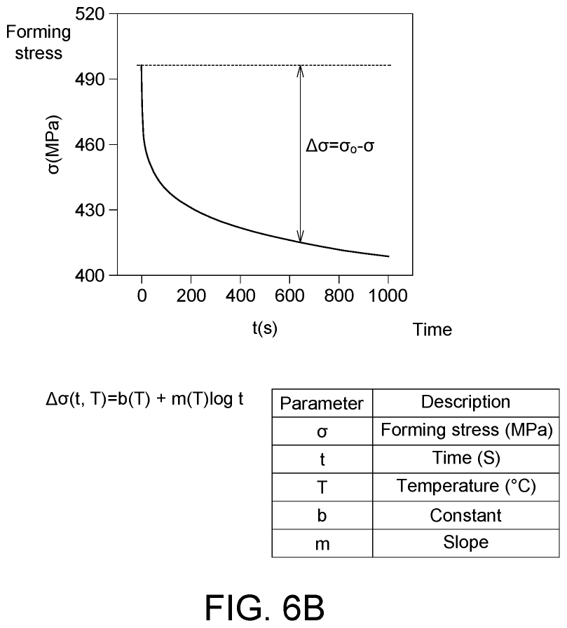

Refer to FIGS. 6A and 6B. FIG. 6A is a flowchart of a hold optimization process according to an embodiment of the disclosure. FIG. 6B is a schematic diagram of reference value of decision holding time parameter. In the hold optimization process, an optimum node position is obtained according to the following steps. Firstly, a temperature parameter at the end of previous process is captured by the system (S601). Next, a required processing time is obtained by the system according to the setting of a final temperature of the process, wherein the final temperature of the process refers to the last temperature of the entire manufacturing process (S602). Then, several sets of decision times are obtained by the system according to built-in equations (S603). Then, whether the required processing time is greater than the decision times is determined by the system to determine whether a holding time parameter matches the optimization target (S604). If the required processing time is less than the decision times, the required processing time and several sets of decision time are simulated (S605). Then, the simulation results are evaluated (S606). Then, a holding time parameter with a highest evaluation score is obtained (S607). In the above steps S602 and S603, the time obtained by the system is a key parameter of the node analyzed in step S401. In steps S602 and S603, the required processing time and several sets of decision times generated by the system are the suggested values generated in step S401. In steps S605-S607, the required processing time and several sets of decision times are simulated, and several simulation results are normalized and evaluated to obtain the holding time parameter with a highest evaluation score (that is, step S402, several suggested values of the key parameter are simulated and evaluated to obtain a decision value of the key parameter). Then, the node position is adjusted by the system according to the decision value (S403).

As indicated in FIG. 6B, the system obtains a reference value for the decision holding time parameter according to a stress relaxation equation as follows: Δσ(t,T)=b(T)+m(T)log ^{t}, wherein σ represents internal forming stress (MPa); t represents time, T represents a temperature (° C.), b represents a constant, m represents a constant. Δσ=σ₀−σ, wherein Δσ represents the difference between the initial stress σ₀ and the final stress σ. The stress relaxation refers to the phenomenon that the internal forming stress will diminish with time when an external force is applied on a workpiece and causes the workpiece to deform and further maintains the deformation at a fixed level. For instance, at the beginning when the external force is applied on the workpiece, the internal stress σ₀ of the workpiece is 500 MPa; meanwhile, if the external force applied on the workpiece is removed off the workpiece, the workpiece will have a larger amount of springback. On the other hand, if the external force applied on the workpiece remains unchanged, the internal forming stress σ of the workpiece will diminish along with the passing of the forming time of the workpiece (for instance, the internal forming stress σ diminishes to 450 MPa). That is, the internal forming stress σ gradually decreases with the time; meanwhile, when the external force applied on the workpiece is removed, the workpiece will have a smaller amount of springback. Thus, the stress relaxation equation is a straightforward method for obtaining the decision holding time parameter.

Then, several simulation results are normalized and evaluated by the system to obtain a time parameter with a highest evaluation score. For instance, the system evaluates several simulation results according to value factors such as heating temperature, stamping speed, forming force, forming limit, holding time and thinning rate, and the evaluation with a highest evaluation score indicates that the simulation result of the optimized forming curve best meets the expectation. Thus, the system can obtain the time parameter according to the evaluation score. Then, a node position on the selected processing curve is adjusted according to the optimized time parameter, and the final forming curve matching the optimization target is outputted.

As indicated in FIGS. 4A and 4C, the adjustment of node position includes moving at least one node position on the Hold curve (for instance, node 3′ is moved leftward with respect to node 3), so that the optimized subsection of the processing curve (subsection between node 2′ and node 3′ of the processing curve) corresponds to the holding time parameter with a highest evaluation score. Then, the nodes 3 and 4 of the Link 2 curve connected to the Hold curve both are moved leftward to obtain the final forming curve.

According to the forming method of a processing curve in a stamping process disclosed in above embodiments of the disclosure, suitable processing curves are determined according to material characteristics and process requirements; at least two of the processing curve are selected and superimposed to form a basic forming curve; whether the selected processing curve in each subsection matches the optimization target is determined. Thus, the system can calculate the probability of the finished product being ruptured according to material forming limit to reduce the risk of the workpiece being ruptured or over-thinning. Meanwhile, the system can obtain suitable hold temperature and holding time according to machine limit or equation to reduce the amount of springback of the workpiece and increase the size precision of the workpiece, so that the efficiency of the manufacturing process can be maximized.

While the disclosure has been described by way of example and in terms of the preferred embodiment(s), it is to be understood that the disclosure is not limited thereto. Based on the technical features embodiments of the present disclosure, a person ordinarily skilled in the art will be able to make various modifications and similar arrangements and procedures without breaching the spirit and scope of protection of the disclosure. Therefore, the scope of protection of the present disclosure should be accorded with what is defined in the appended claims.

What is claimed is:

1. A forming method of a processing curve in a stamping process, comprising:
establishing a plurality of processing curves, and setting an optimization target on the processing curves according to material characteristics of a workpiece, process requirements and a finished product CAD file;
selecting and superimposing at least two of the processing curves to form a basic forming curve, wherein each subsection of the basic forming curve corresponds to a selected processing curve of the processing curves; and
determining whether the selected processing curve in each subsection of the basic forming curve matches the optimization target.

2. The forming method according to claim 1, wherein if it is determined that the selected processing curve in each subsection of the basic forming curve does not match the optimization target, the method further comprises:
adjusting a node position on the selected processing curve; and
outputting a final forming curve matching the optimization target.

3. The forming method according to claim 1, wherein the basic forming curve has a forming stage at which the selected processing curve is optimized, and the optimization of the selected processing curve comprises:
calculating a worse strain value when the workpiece has a largest deformation by a cross section method; and
obtaining a suitable temperature or a strain rate interval according to the workpiece material to determine whether a rupture strain value of the workpiece is greater than the worse strain value.

4. The forming method according to claim 3, further comprising:
setting a plurality of sets of temperature parameters and puncher speed parameters when the rupture strain value is greater than the worse strain value; and
simulating the sets of temperature parameters and puncher speed parameters and evaluating simulation results to obtain a temperature parameter and a speed parameter with a highest evaluation score.

5. The forming method according to claim 2, wherein adjusting the node position comprises:
analyzing a key parameter of the node to generate several suggested values;
simulating and evaluating the suggested values of the key parameter to obtain a decision value of the key parameter; and
adjusting the node position according to the decision value of the key parameter.

6. The forming method according to claim 5, wherein evaluating the suggested values comprises performing an evaluation using a forming limit diagram.

7. The forming method according to claim 1, wherein the basic forming curve has a holding stage at which the selected processing curve is optimized, and the optimization of the selected processing curve comprises:
capturing a temperature parameter at an end of a previous process;
obtaining a required processing time according to a final temperature of the process;
obtaining a plurality of sets of decision times according to built-in equations; and
determining whether the required processing time is greater than the sets of decision times to determine whether a holding time parameter matches the optimization target.

8. The forming method according to claim 7, further comprising:
simulating the required processing time and the sets of decision times, and normalizing and evaluating several simulation results to obtain a holding time parameter with a highest evaluation score.

9. The forming method according to claim 1, wherein each selected processing curve is a template segment.

10. The forming method according to claim 1, wherein the basic forming curve has a forming stage, at which the optimization target is efficiency and forming limit.

11. The forming method according to claim 1, wherein the basic forming curve has a holding stage, at which the optimization target is a small amount of springbuck and high level of flatness.

12. The forming method according to claim 1, wherein the basic forming curve has a demolding stage, at which the optimization target is demolding speed and temperature.
